(19) United States
(12) Patent Application Publication
(10) Pub. No.: US 2026/0046756 A1
(43) Pub. Date: Feb. 12, 2026

(54) ENHANCED CELL (RE)SELECTION PRIORITIZATION IN NON-TERRESTRIAL NETWORKS

(71) Applicant: InterDigital Patent Holdings, Inc., Wilmington, DE (US)

(72) Inventors: Dylan Watts, Montreal (CA); Brian Martin, Farnham (GB); Oumer Teyeb, Montreal (CA)

(73) Assignee: InterDigital Patent Holdings, Inc., Wilmington, DE (US)

(21) Appl. No.: 19/101,319

(22) PCT Filed: Aug. 4, 2023
(86) PCT No.: PCT/US2023/029519

§ 371 Date: Feb. 5, 2025

Related U.S. Application Data
(60) Provisional application No. 63/395,576, filed on Aug. 5, 2022.

(51) Int. Cl. H04W 48/18

(52) U.S. Cl. CPC H04W 48/18

(57) ABSTRACT

Systems, methods, and instrumentalities are described herein for enhanced cell (re)selection prioritization in non-terrestrial networks (NTNs). Cell (re)selection may be determined for terrestrial networks (TNs) and NTNs. Cell (re)selection may be determined for TNs or NTNs based on a wireless transmit/receive unit (WTRU) location and the coverage area associated with the TN or NTN. For example, a WTRU may be connected to a first network and perform (re)selection to a second network based on being outside a coverage area associated with the first network. The WTRU may prioritize a network type, for example, if it is within a coverage area of multiple networks.

### CROSS-REFERENCE TO RELATED APPLICATIONS

The application claims the benefit of U.S. Provisional Application 63/395,576, filed Aug. 5, 2022, the contents of which are incorporated by reference in their entirety herein.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, and instrumentalities are described herein for enhanced cell (re)selection prioritization in non-terrestrial networks (NTNs). Cell (re)selection may be determined for terrestrial networks (TNs) and NTNs. Cell (re)selection may be determined for TNs or NTNs based on a wireless transmit/receive unit (WTRU) location and the coverage area associated with the TN or NTN. For example, a WTRU may be connected to a first network and perform (re)selection to a second network based on being outside a coverage area associated with the first network. The WTRU may prioritize a network type, for example, if it is within a coverage area of multiple networks.

A WTRU may perform (re)selection to a network based on the WTRU's location and a network's coverage area. The WTRU may receive configuration information that includes location information associated with a TN. The location information associated with the TN may indicate a TN coverage area (e.g., geographic description of the TN coverage area, such as a coordinate and/or radius) and/or frequency information (e.g., a frequency, set of frequencies, range of frequencies, etc.) associated with the TN. The WTRU may determine a distance between the WTRU and a terrestrial reference point associated with the TN coverage area. The WTRU may determine whether the distance between the WTRU and the terrestrial reference point is above or equal to a threshold associated with the location information. For example, the WTRU may be within a TN coverage area if the distance between the WTRU and the terrestrial reference point is below the threshold. The WTRU may be outside the TN coverage area if the distance between the WTRU and the terrestrial reference point is above or equal to the threshold. The WTRU may select a network type (e.g., TN or NTN) based on whether the distance between the WTRU and the terrestrial reference point is above or equal to the threshold. For example, the WTRU may select an NTN if the distance between the WTRU and the terrestrial reference point is above or equal to the threshold (e.g., WTRU is outside TN coverage area). The WTRU may select the TN if the distance between the WTRU and the terrestrial reference point is below the threshold (e.g., WTRU is within TN coverage area). The WTRU may perform measurement(s) on the selected network type (e.g., frequencies associated with the selected network type).

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of multiple interfaces in a non-terrestrial network.

FIG. 3 illustrates an example of a user plane and a control plane protocol stack for a transparent satellite configuration.

FIGS. 4A and 4B illustrate an example of cell selection and re-selection procedures in a network.

FIG. 5 illustrates an example of cell selection based on a WTRU location and distance from network coverage areas.

FIG. 6 illustrates an example of grouping one or more frequencies for cell ranking where the one or more frequencies may be associated with different network types.

FIG. 7 illustrates an example of prioritization of a frequency over a network type.

FIG. 8 illustrates an example of prioritization of a network type over frequency.

### EXAMPLE NETWORKS FOR IMPLEMENTATION OF THE EMBODIMENTS

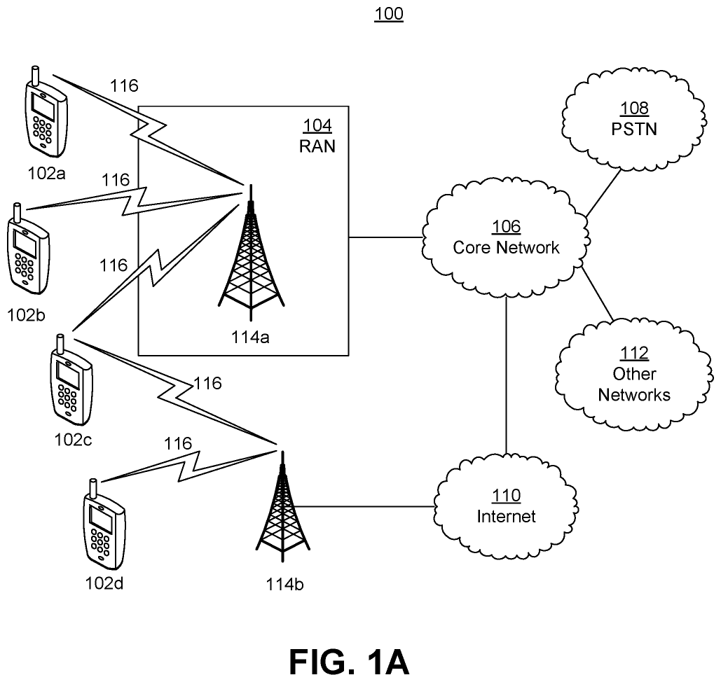

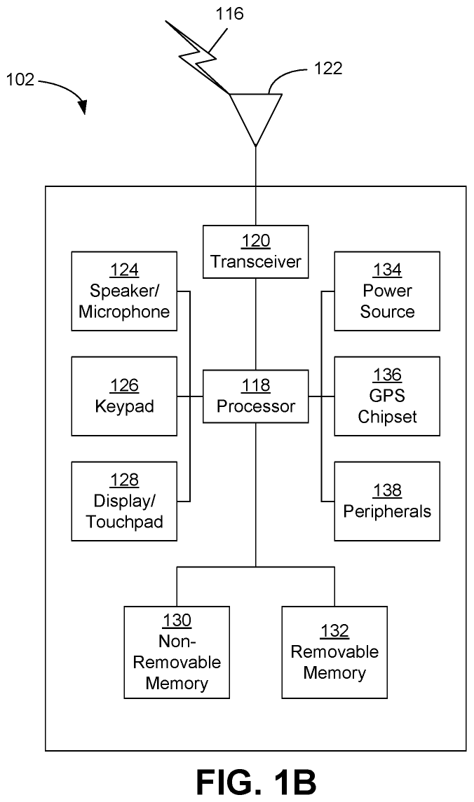

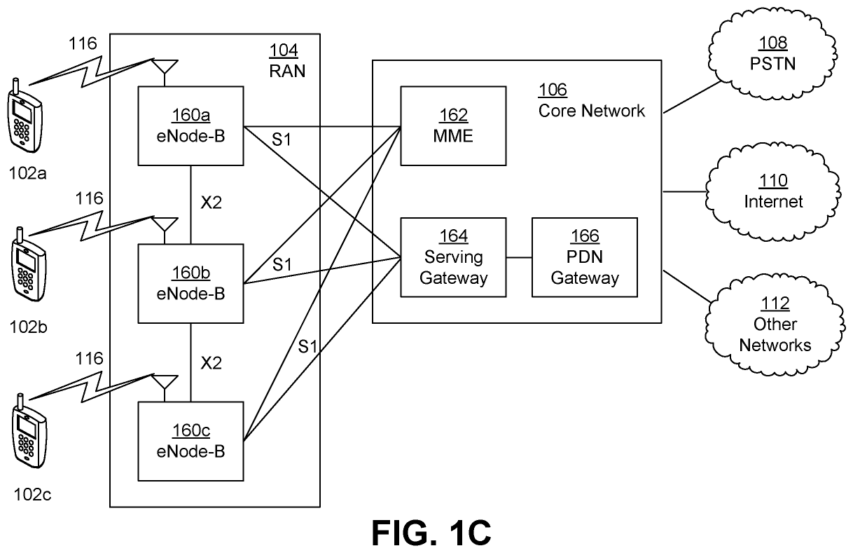

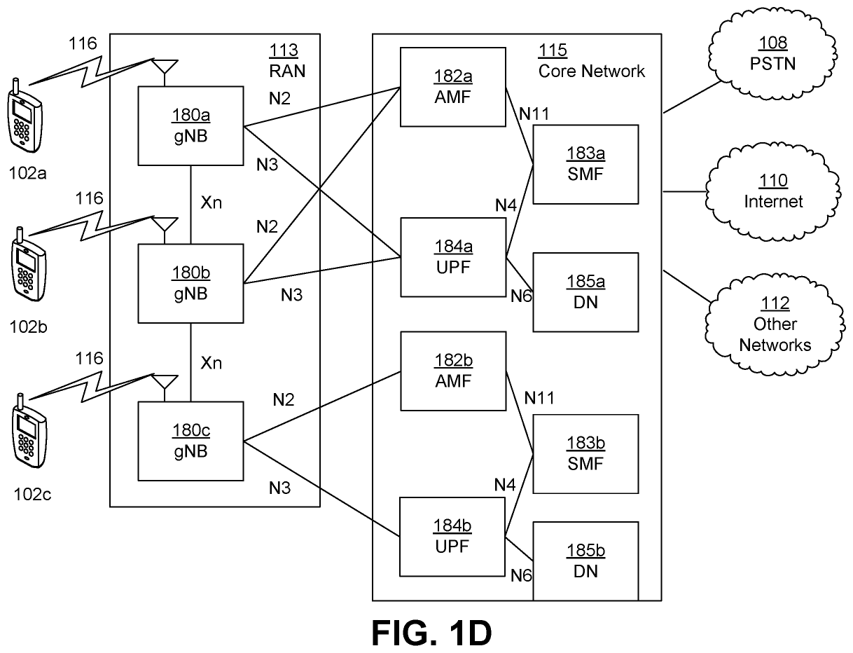

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and instrumentalities are described herein for enhanced cell (re)selection prioritization in non-terrestrial networks (NTNs). Cell (re)selection may be determined for terrestrial networks (TNs) and NTNs. Cell (re)selection may be determined for TNs or NTNs based on a wireless transmit/receive unit (WTRU) location and the coverage area associated with the TN or NTN. For example, a WTRU may be connected to a first network and perform (re)selection to a second network based on being outside a coverage area associated with the first network. The WTRU may prioritize a network type, for example, if it is within a coverage area of multiple networks.

A WTRU may perform (re)selection to a network based on the WTRU's location and a network's coverage area. The WTRU may receive configuration information that includes location information associated with a TN. The location information associated with the TN may indicate a TN coverage area (e.g., geographic description of the TN coverage area, such as a coordinate and/or radius) and/or frequency information (e.g., a frequency, set of frequencies, range of frequencies, etc.) associated with the TN. The WTRU may determine a distance between the WTRU and a terrestrial reference point associated with the TN coverage area. The WTRU may determine whether the distance between the WTRU and the terrestrial reference point is above or equal to a threshold associated with the location information. For example, the WTRU may be within a TN coverage area if the distance between the WTRU and the terrestrial reference point is below the threshold. The WTRU may be outside the TN coverage area if the distance between the WTRU and the terrestrial reference point is above or equal to the threshold. The WTRU may select a network type (e.g., TN or NTN) based on whether the distance between the WTRU and the terrestrial reference point is above or equal to the threshold. For example, the WTRU may select an NTN if the distance between the WTRU and the terrestrial reference point is above or equal to the threshold (e.g., WTRU is outside TN coverage area). The WTRU may select the TN if the distance between the WTRU and the terrestrial reference point is below the threshold (e.g., WTRU is within TN coverage area). The WTRU may perform measurement(s) on the selected network type (e.g., frequencies associated with the selected network type).

Cell (re)selection may be prioritized between different network types (e.g., terrestrial and non-terrestrial) and/or between different non-terrestrial network deployment scenarios (e.g., low Earth orbiting (LEO) or geostationary Earth orbiting (GEO)). Cell (re)selection prioritization criterion, cell (re)selection prioritization methods, durations in which cell reselection prioritization may be applied, methods to report WTRU cell (re)selection prioritization, and other examples are described herein.

In examples, a WTRU may prioritize camping on a terrestrial cell versus a non-terrestrial cell, and/or in a non-terrestrial deployment scenario (e.g., LEO versus GEO), for example, based on application of a cell (re)selection prioritization configuration. A prioritization configuration and/or activation of a configuration may be provided, for example, via RRC in an RRCRelease or RRCReleasewithSuspend message, via system information (SI), random access message, and/or paging. Cell (re)selection prioritization may include, for example, grouping frequencies associated with a network type and attempting to camp on those cells before attempting to camp on other cells.

In examples, a WTRU may start and/or enable cell (re)selection prioritization via an indication (e.g., an explicit indication), and/or implicitly, for example, based on the WTRU state, configuration, and/or characteristics. A WTRU may (e.g., alternatively) receive and evaluate an associated set of criteria to start cell (re)selection prioritization based on, for example, the WTRU speed and/or a distance metric.

A WTRU may apply a cell (re)selection prioritization configuration for a finite duration, for example, based on (e.g., subject to) a timer. The WTRU may start the timer, for example, based on (e.g., upon) application of the prioritization configuration. The WTRU may (e.g., based on/upon timer expiry) revert back to a different (e.g., default) configuration.

A WTRU may report to the network that the WTRU has applied cell (re)selection prioritization. A report may be provided, for example, via random access signaling, such as MsgA/Msg3/Msg5.

In examples, a WTRU may prioritize camping on a terrestrial cell versus a non-terrestrial cell, and/or in a non-terrestrial deployment scenario (e.g., LEO versus GEO), for example, based on application of a cell (re)selection prioritization configuration. Prioritization configuration information and/or activation of a configuration may be provided, for example, via signaling (e.g., RRC signaling in an RRCRelease or RRCReleasewithSuspend message), via system information (SI), random access message, and/or paging. Cell (re)selection prioritization may include, for example, grouping frequencies associated with a network type and attempting to camp on those cells before attempting to camp on other cells.

In examples, a WTRU may start and/or enable cell (re)selection prioritization via an indication (e.g., an explicit indication), and/or implicitly, for example, based on the WTRU state, configuration, and/or characteristics. A WTRU may (e.g., alternatively) receive and evaluate an associated set of criteria to start cell (re)selection prioritization based on, for example, the WTRU speed and/or a distance metric.

A WTRU may apply a cell (re)selection prioritization configuration for a finite duration, for example, based on (e.g., subject to) a timer. The WTRU may start tracking a time (e.g., via the timer), for example, based on (e.g., upon) application of the prioritization configuration. The WTRU may (e.g., based on/upon timer expiry) revert back to a different (e.g., default) configuration.

A WTRU may report to the network that the WTRU has applied cell (re)selection prioritization. A report may be provided, for example, via random access signaling, such as MsgA/Msg3/Msg5.

Non-Terrestrial Networks (NTN) may facilitate deployment of wireless networks in areas where land-based antennas may be impractical, for example due to geography or cost. NTNs coupled with TNs may enable network coverage (e.g., ubiquitous 5G network coverage). NTN deployments may support basic talk and text anywhere in the world. NTN, TN, and low-orbit satellites may enable enhanced services, such as web browsing for NTNs.

An NTN may include an aerial or space-borne platform which may (e.g., via a gateway (GW)) transport signals from a land-based based gNB to a WTRU and vice-versa. An NTN may support power class 3 WTRUs with omnidirectional antenna and linear polarization, and/or a (e.g., very) small aperture antenna (VSAT) terminal with directive antenna and circular polarization. Support for (e.g., LTE-based) narrow-band IoT (NB-IOT) and eMTC type devices may be supported by NTNs. NTN WTRUs may be GNSS capable.

Aerial or space-borne platforms may be classified in terms of orbit, e.g., low-earth orbit (LEO) satellites with an altitude range of 300-1500 km, geostationary earth orbit (GEO) satellites with an altitude at 35,786 km, medium-earth orbit (MEO) satellites with altitude range 7000-25000 km, and high-altitude platform stations (HAPS) with an altitude of 8-50 km. Satellite platforms may be (e.g., further) classified as having a transparent or regenerative payload. Transparent satellite payloads may implement frequency conversion and RF amplification in uplink and/or downlink. Multiple transparent satellites may be connected to a land-based gNB (e.g., one land-based gNB). Regenerative satellite payloads may implement a full gNB or gNB DU onboard the satellite. Regenerative payloads may perform digital processing on signals, e.g., including demodulation, decoding, re-encoding, re-modulation, and/or filtering.

One or more of the following radio interfaces may be defined (e.g., configured) in NTN: a feeder-link (e.g., a wireless link between the GW and satellite); a service link (e.g., a radio link between the satellite and WTRU); and/or an inter-satellite link (ISL) (e.g., a transport link between satellites). An ISL may be supported (e.g., only) by regenerative payloads. An ISL may be, for example, a radio (e.g., 3GPP radio) or optical interface (e.g., proprietary optical interface).

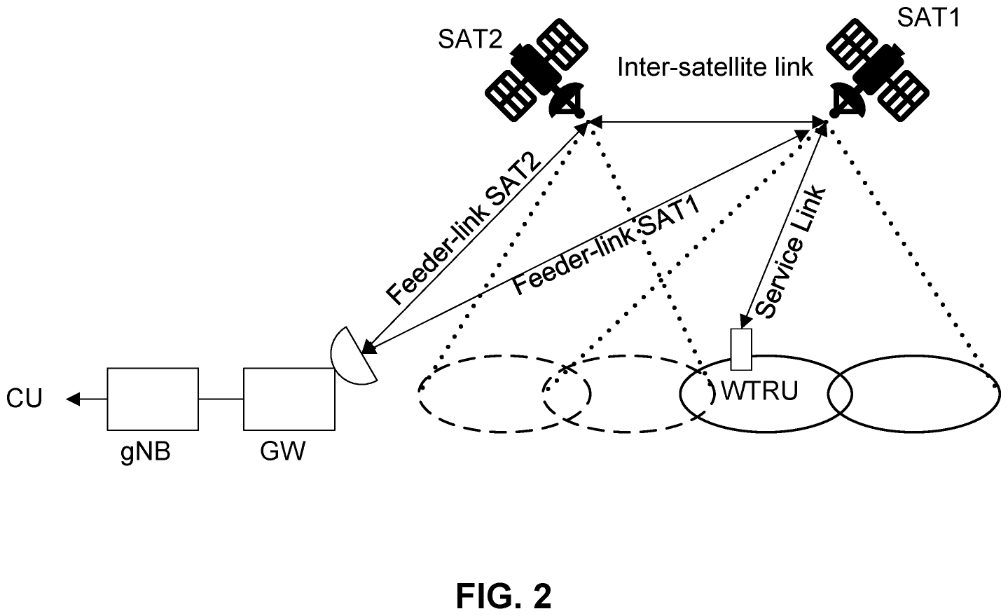

FIG. 2 illustrates an example of multiple interfaces in a non-terrestrial network. An interface (e.g., different 3GPP interfaces) may be used for a (e.g., each) radio link, for example, based on a satellite payload configuration. An NR-Uu radio interface may be used for a service link and/or a feeder-link, for example, for a transparent payload. An NR-Uu interface may be used on the service link, for example, for a regenerative payload. A satellite radio interface (SRI) may be used for the feeder-link, for example, for a regenerative payload. A UP/CP protocol stack may be provided for a payload configuration (e.g., each payload configuration).

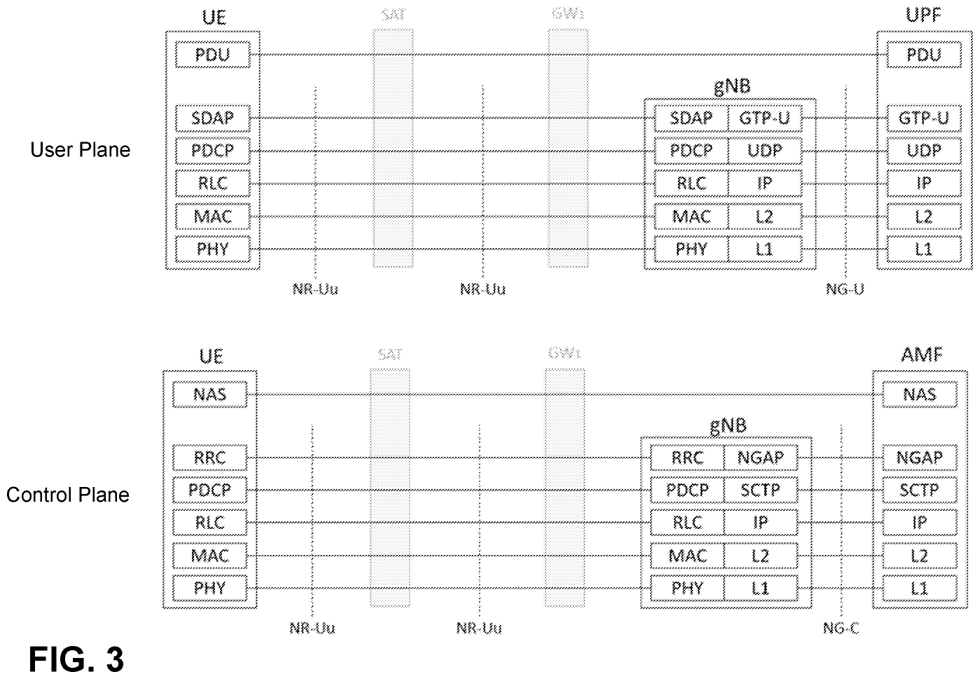

FIG. 3 illustrates an example of a user plane and a control plane protocol stack for a transparent satellite configuration. An NTN satellite may support multiple cells. A cell (e.g., each cell) may include one or more satellite beams. The one or more satellite beams may cover a footprint on earth (e.g., like a terrestrial cell). Satellite beams may range in diameter, for example, from 100-1000 km in LEO deployments, and 200-3500 km diameter in GEO deployments. Beam footprints in GEO deployments may remain fixed relative to earth. The area covered by a beam/cell in LEO deployments may change over time, e.g., due to satellite movement. Beam movement may be classified as earth moving, for example, if the LEO beam moves continuously across the earth, or earth fixed, for example, if the beam is steered to remain covering a fixed location until a cell (e.g., a new cell) overtakes the coverage area (e.g., in a discrete and coordinated change).

A round-trip time (RTT) and/or a maximum differential delay may be larger (e.g., significantly larger) for NTN platforms than for terrestrial systems, for example, due to the altitude of NTN platforms and/or due to beam diameter. In an example of a transparent NTN deployment, RTT may range from 25.77 ms (e.g., for LEO @ 600 km altitude) to 541.46 ms (e.g., for GEO), with a differential delay (e.g., a maximum differential delay) from 3.12 ms to 10.3 ms. The RTT of a regenerative payload may be approximately half that of a transparent payload. Transparent configuration information may include service and feeder links, whereas the RTT of a regenerative payload may consider (e.g., only) the service link. A WTRU may perform timing pre-compensation (e.g., prior to initial access), for example, to reduce/minimize an impact to existing network (e.g., NR) systems (e.g., to avoid preamble ambiguity or to properly time reception windows).

A pre-compensation procedure may involve the WTRU obtaining its position (e.g., via GNSS), and/or the feeder-link (e.g., or common) delay and satellite position (e.g., via satellite ephemeris data). The satellite ephemeris data may be (e.g., periodically) broadcasted in system information (SI). Satellite ephemeris data may include the satellite speed, direction, and/or velocity. The WTRU may estimate the distance (e.g., and thus delay) from the satellite. The WTRU may add the feeder-link delay component to obtain the full WTRU-gNB RTT, which may be used to offset timers, reception windows, and/or timing relations. In some examples, frequency compensation may be performed by the network.

WTRU mobility and measurement reporting may be provided. The difference in RSRP between cell center and cell edge may not be as pronounced in NTN as in terrestrial systems. For example, measurement-based mobility may become less reliable in an NTN environment due to a larger region of cell overlap. A network (e.g., a 3GPP network) may utilize a conditional handover and/or measurement reporting triggers, which may rely on location and time. Enhanced mobility may be implemented, for example, in LEO deployments, where (e.g., due to satellite movement) a stationary WTRU may perform mobility (e.g., approximately every seven seconds), depending on deployment characteristics.

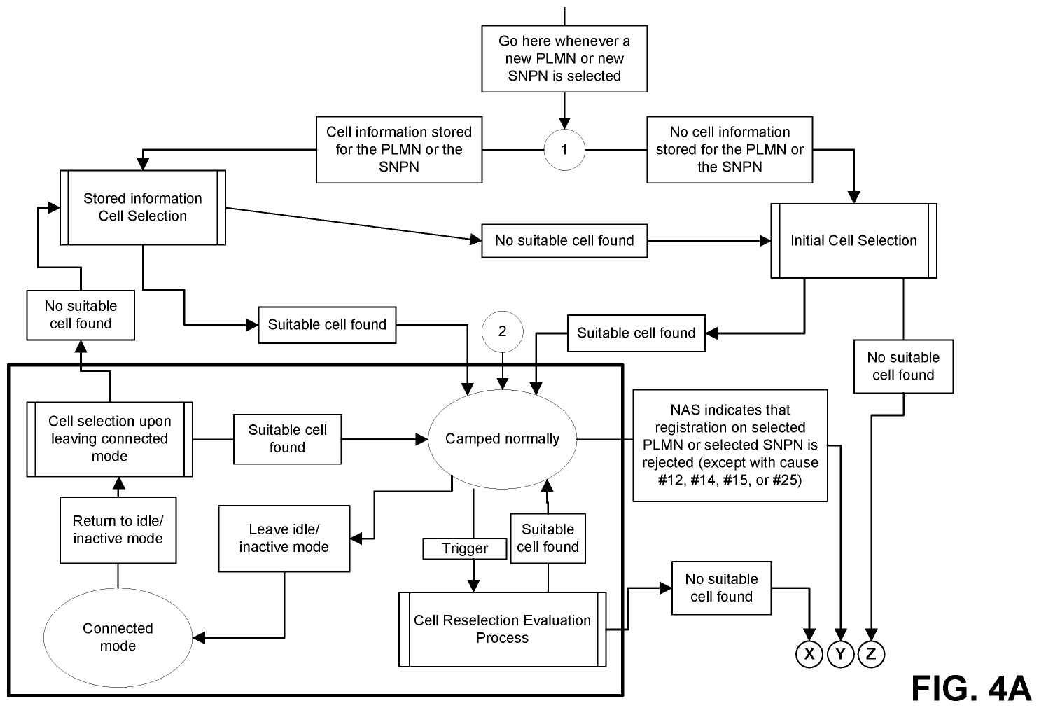

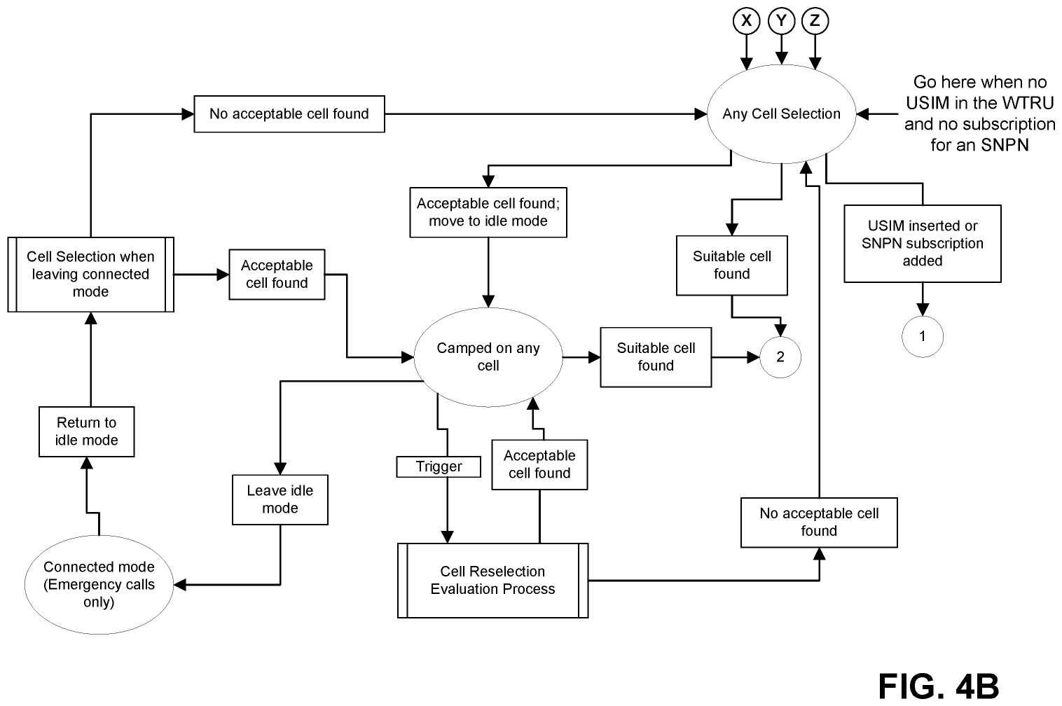

A network (e.g., NR) cell selection/re-selection procedure may be complex, for example, as illustrated in FIGS. 4A and 4B. Examples described herein may focus on the portion of the network cell selection/reselection procedure highlighted by the box in FIG. 4A, which may cover aspects related to going from RRC_CONNECTED to RRC_IDLE/RRC_INACTIVE (e.g., based on/upon reception of an RRC Release message or transitory cell selection done during RRC Re-establishment), e.g., if (e.g., when) a WTRU is able to find a suitable cell to camp on.

FIGS. 4A and 4B illustrate examples of cell selection and re-selection procedures in a network (e.g., a NR network). Cell selection may include a WTRU searching network (e.g., NR) frequency bands. A strong cell (e.g., the strongest cell) may be identified for a carrier frequency (e.g., each carrier frequency), for example, as per the CD-SSB. A WTRU may read cell system information broadcast to identify the PLMN(s) to find a suitable cell to camp on. A suitable cell may be a cell for which the measured cell attributes satisfy a cell selection criterion. The cell PLMN may be the selected PLMN, a registered, or an equivalent PLMN. The cell may not be barred or reserved. The cell may not be part of a tracking area in a list of forbidden tracking areas for roaming.

A WTRU may camp on a cell on a transition from a connected state (e.g., such as RRC_CONNECTED or RRC_INACTIVE) to an idle state (e.g., such as RRC_IDLE). A WTRU may camp on a cell as result of cell selection, for example, according to the frequency assigned by RRC in a state transition message, e.g., if any.

The cell selection criterion (e.g., known as criterion S) may be fulfilled, for example, if (e.g., when):

$$Srxlev > 0 AND Squal > 0$$

$$where :$$

$$Srxlev = {Q}_{rxlevmeas} - ( {Q}_{rxlevmln} + {Q}_{rxlevminoffset} ) - {P}_{c o mpensation} - {Qoffset}_{temp}$$

$$Squal = {Q}_{qualmeas} - ( {Q}_{qualmin} + {Q}_{qualminoffset} ) - {Qoffset}_{temp}$$

Where Table 1 describes examples of parameters for cell selection criterion:

TABLE 1
Example of parameters for cell selection criterion

| | |
|---|---|
| Srxlev | Cell selection RX level value (dB) |
| Squal | Cell selection quality value (dB) |
| Qoffsetₜₑₘₚ | Offset temporarily applied to a cell (dB) |
| Qᵣₓₗₑᵥₘₑₐₛ | Measured cell RX level value (e.g., RSRP) |
| Q_{qualmeas} | Measured cell quality value (e.g., RSRQ) |
| Qᵣₓₗₑᵥₘᵢₙ | Minimum RX level in the cell (dBm). If the WTRU supports SUL |
| | frequency for this cell, Qᵣₓₗₑᵥₘᵢₙ may be obtained from q- |
| | RxLevMinSUL, if present, in SIB1, SIB2 and SIB4, additionally, |
| | if Q_{rxlevminoffsetcellSUL} is present in SIB3 and SIB4 for the |
| | concerned cell, this cell specific offset may be added to the |
| | corresponding Qrxlevmin to achieve a minimum RX level in the |
| | concerned cell; else Qᵣₓₗₑᵥₘᵢₙ may be obtained from q-RxLevMin |
| | in SIB1, SIB2 and SIB4, additionally, if Q_{rxlevminoffsetcell} is present |
| | in SIB3 and SIB4 for the concerned cell, this cell specific offset |
| | may be added to the corresponding Qrxlevmin to achieve the |
| | minimum RX level in the concerned cell. |
| Q_{qualmin} | Minimum quality level in the cell (dB). Additionally, if |
| | Q_{qualminoffsetcell} is signaled for the concerned cell, this cell specific |
| | offset may be added to achieve the minimum quality level in the |
| | concerned cell. |
| Q_{rxlevminoffset} | Offset to the signalled Qᵣₓₗₑᵥₘᵢₙ taken into account in the Srxlev |
| | evaluation as a result of a periodic search for a higher priority |
| | PLMN while camped normally in a VPLMN. |
| Q_{qualminoffset} | Offset to the signalled Q_{qualmin} taken into account in the Squal |
| | evaluation as a result of a periodic search for a higher priority |
| | PLMN while camped normally in a VPLMN. |
| P_{compensation} | For FR1, if the WTRU supports the additionalPmax in the NR- |
| | NS-PmaxList, if present, in SIB1, SIB2 and SIB4: |
| | max(P_{EMAX1} − P_{PowerClass}, 0) − (min(P_{EMAX2}, P_{PowerClass}) − |
| | min(P_{EMAX1}, P_{PowerClass})) (dB); |
| | else: |
| | max(P_{EMAX1} − P_{PowerClass}, 0) (dB) |
| | For FR2, P_{compensation} may be set to 0. |
| | For IAB-MT, P_{compensation} may be set to 0. |
| P_{EMAX1}, P_{EMAX2} | Maximum TX power level of a WTRU may use when |
| | transmitting on the uplink in the cell (dBm) defined as P_{EMAX}. If |
| | WTRU supports SUL frequency for this cell, P_{EMAX1} and P_{EMAX2} |
| | are obtained from the p-Max for SUL in SIB1 and NR-NS- |
| | PmaxList for SUL respectively in SIB1, SIB2 and SIB4, else |
| | P_{EMAX1} and P_{EMAX2} are obtained from the p-Max and NR-NS- |
| | PmaxList respectively in SIB1, SIB2 and SIB4 for normal UL. |
| P_{PowerClass} | Maximum RF output power of the WTRU (dBm) according to |
| | the WTRU power class. |

The signaled values Q_{rxlevminoffset} and Q_{qualminoffset} may (e.g., only) be applied, for example, if (e.g., when) a cell is evaluated for cell selection as a result of a periodic search for a higher priority public land mobile network (PLMN) while camped (e.g., normally) in a visited public land mobile network (VPLMN). A WTRU may (e.g., during a periodic search for higher priority PLMN) check the S criteria of a cell using parameter values stored from a different cell of the higher priority PLMN.

Cell Reselection may be performed, for example, by a WTRU in RRC_IDLE/RRC_INACTIVE. A WTRU may perform intra-frequency, inter-frequency, and/or inter-RAT cell re-selection.

A WTRU may receive configuration information indicating (e.g., be configured with) priorities among one or more RATs (e.g., prioritize camping on NR over LTE whenever an NR cell may be available) and/or among frequencies within a RAT (e.g., fa may have a high priority, fb may have a medium priority, fc may have a low priority, etc.). A neighbor cell list (NCL) may be provided to a WTRU. An NCL may indicate which neighbor cells (e.g., intra-frequency, inter-frequency, inter-RAT) may be considered for cell reselection. Allow-lists may be provided to the WTRU. An allow-list may indicate the neighboring cells that may be considered for re-selection. Exclude-lists may be provided to the WTRU. Exclude lists may indicate the neighboring cells that unsuitable for re-selection.

A WTRU may (e.g., try to) camp on a cell operating with a high priority RAT (e.g., the highest priority RAT) and with a high priority frequency (e.g., the highest priority frequency).

The WTRU may choose not to perform intra-frequency measurements, for example, if the serving cell fulfils Srxlev>S_{intraSearchP} and Squal>S_{intraSearchQ}. The WTRU may (e.g., otherwise) perform intra-frequency measurements.

The WTRU may choose not to perform measurements of NR inter-frequency cells of equal or lower priority, or inter-RAT frequency cells of lower priority, for example, if the serving cell fulfils Srxlev>S_{nonIntraSearchP} and Squal>S_{nonIntraSearchQ}. The WTRU may (e.g., otherwise) perform measurements of network (e.g., NR) inter-frequency cells of equal or lower priority, and/or inter-RAT frequency cells of lower priority. Table 2 provides descriptions of parameters that may be used in measurement criteria.

TABLE 2
Example of parameters in measurement criteria

| | |
|---|---|
| S_{IntraSearchP} | Srxlev threshold (in dB) for intra-frequency |
| | measurements. |
| S_{IntraSearchQ} | Squal threshold (in dB) for intra-frequency |
| | measurements. |
| S_{nonIntraSearchP} | Srxlev threshold (in dB) for NR inter-frequency and |
| | inter-RAT measurements. |
| S_{nonIntraSearchQ} | Squal threshold (in dB) for NR inter-frequency and |
| | inter-RAT measurements. |

A WTRU may perform the cell rankings of the concerned cells, for example, if (e.g., when) the WTRU decides to perform intra-frequency measurements for cell re-selection based on the criteria. Inter-frequency and/or inter-RAT reselection may be based on (e.g., absolute) priorities where a WTRU may try to camp on an available high priority frequency (e.g., the highest priority frequency available).

A cell-ranking criterion (e.g., referred to us Criteria R) for serving cell (Rₛ) and for neighboring cells (Rₙ) may be defined by:

$${R}_{s} = {Q}_{m e a s , s} + {Q}_{hyst} - {Qoffset}_{temp}$$

$${R}_{n} = {Q}_{meas , n} - Qoffset - {Qoffset}_{temp}$$

where Table 3 provides descriptions of parameters in cell ranking criterion:

TABLE 3
Example of parameters in cell ranking criterion

| | |
|---|---|
| Qₘₑₐₛ | RSRP measurement quantity used in cell reselections. |
| Qoffset | For intra-frequency: Equal to Qoffset_{s, n}, if Qoffset_{s, n} |
| | is valid, otherwise equal to zero. |
| | For inter-frequency: Equal to Qoffset_{s, n} plus |
| | Qoffset_{frequency}, if Qoffset_{s, n} is valid, |
| | otherwise equal to Qoffset_{frequency}. |
| Qoffsetₜₑₘₚ | Offset temporarily applied to a cell. |

A WTRU may perform ranking of (e.g., all) cells that fulfil the cell selection criterion S (e.g., as described herein).

Cells may be ranked according to the R criteria (e.g., as described herein). For example, cells may be ranked by deriving Q_{meas,n} and Q_{meas,s} and calculating the R values using averaged RSRP results. The WTRU may perform cell reselection to a high ranked cell (e.g., the highest ranked cell), for example, if range ToBestCell is not (e.g., may not be) configured. The WTRU may perform cell reselection to the cell with the highest number of beams above the threshold (e.g., abs ThreshSS-BlocksConsolidation) among the cells whose R value may be within range ToBestCell of the R value of a high ranked cell (e.g., the highest ranked cell), for example, if rangeToBestCell is (e.g., may be) configured. The WTRU may perform cell reselection to the highest ranked cell among multiple cells.

The WTRU may reselect a cell (e.g., a new cell), for example, if one or more of the following conditions are met: the cell (e.g., the new cell) is (e.g., may be) better than the serving cell according to the cell reselection criteria (e.g., as described herein) during a time interval TreselectionRAT; and/or more than a threshold of time (e.g., a duration of time, such as 1 second) has (e.g., may have) elapsed since the WTRU camped on the serving cell (e.g., the current serving cell).

A network (e.g., NR and LTE) may support non-terrestrial networks. Coverage (e.g., TN and NTN coverage, for example, which may include a coverage area, a coordinate (e.g., reference coordinate) associated with the coverage area, and/or a radius associated with the coverage (e.g., with respect to the coordinate)) may be provided (e.g., via configuration information) by a satellite relaying transmissions to a gNB (e.g., via a gateway). There may be regions (e.g., coverage area) where terrestrial and non-terrestrial coverage overlap, for example, based on the cell diameters (e.g., large cell diameters) for non-terrestrial cells. NTN cell (re)selection and terrestrial-to-non-terrestrial cell (re)selection, and cell (re)selection between different NTN deployment scenarios (e.g., LEO or GEO) may be implemented.

In some examples, both types of network coverage may be available to a WTRU. A WTRU in an IDLE/INACTIVE mode (e.g., RRC IDLE/INACTIVE mode) may camp on one network type or another, which may offer different advantages. For example, camping on a non-terrestrial cell may provide better power savings from a WTRU power saving point of view, e.g., due to non-terrestrial cells providing much wider coverage. Camping on a non-terrestrial cell may reduce the number of cell measurements, system information (SI) reading, and cell reselections. Camping on a terrestrial cell may provide an advantage from a latency point of view, for example, due to (e.g., much) larger propagation delays in non-terrestrial networks. For example, a signaling exchange to perform an RRC establishment or an RRC Resume procedure may introduce a delay (e.g., a significant delay) to connection establishment and/or overall signaling throughput reduction if (e.g., when) a connection is established.

TN-NTN cell (re)selection procedures may utilize measurement-based criteria without considering the difference characteristics (e.g., vastly different characteristics) of terrestrial and non-terrestrial networks, or between different NTN deployment scenarios. Enhancements to a cell (re)selection procedure may support overlapping TN-NTN coverage, for example, to utilize the power saving benefits of NTN without longer latency, without longer session establishment times, and without limited throughput.

In some examples, a WTRU may prioritize camping on a terrestrial cell over camping on a non-terrestrial cell (e.g., if the WTRU is within coverage of the TN), or on a non-terrestrial deployment scenario (e.g., LEO vs. GEO), which may be referred to as cell (re)selection prioritization.

A WTRU may distinguish between a terrestrial cell and non-terrestrial cell, for example, based on (e.g., via) dedicated frequency (e.g., frequencies) allocated to a network type (e.g., each network type). For example, terrestrial networks may be associated with frequencies f1 to fN while non-terrestrial cells may be associated with frequencies fN+1 to fk. The WTRU may receive configuration information (e.g., assistance information, network type prioritization assistance information) indicating frequency information associated with a TN or an NTN (e.g., frequency, set of frequencies, or range of frequencies associated with the TN or NTN).

In some examples (e.g., deployments), a terrestrial and non-terrestrial cell may share and/or overlap in frequency. A WTRU may determine a cell may be a terrestrial cell or a non-terrestrial cell, for example, based on one or more of the following: a set of one or more cell ID(s) associated with a network type (e.g., each network type); a set of one or more PLMN ID(s) associated with a network type (e.g., each network type); an indication (e.g., explicit indication), for example, within system information (SI) (e.g., an indication may be a flag bit indicating that the cell may be an NTN cell); an implicit indication (e.g., via presence of an information field, such as the presence of SI (SIB19) including NTN-specific information or satellite ephemeris information); access or barring information (e.g., the presence of a barring bit or NTN-specific barring bit); and/or a band indicator indicating a band defined (e.g., exclusively) for a type of network (e.g., provided in the serving cell for cells or carriers indicated in the neighbor list).

Although examples (e.g., as described herein) use prioritization of terrestrial versus non-terrestrial networks, examples may apply (e.g., equally) if (e.g., when) prioritizing between different non-terrestrial network types, and vice-versa. For example, a WTRU may (e.g., similarly) distinguish between different non-terrestrial deployments (e.g., between LEO or GEO deployments) via one or more distinguishing methods (e.g., as described herein). A WTRU may (e.g., additionally) distinguish between an LEO or a GEO satellite, for example, via the ephemeris format (e.g., orbital characteristics or PVT), or other satellite characteristics (e.g., as found in satellite ephemeris data, such as the height or velocity).

Cell (re)selection prioritization criteria may be provided. In some examples (e.g., as described herein), a WTRU may enable/disable cell (re)selection prioritization, select among cell (re)selection prioritization methods, determine a duration to apply cell (re)selection prioritization, report cell (re)selection prioritization characteristics, or prioritize between a cell belonging to a specific network type (e.g., terrestrial or non-terrestrial) or NTN deployment scenario (e.g., LEO or GEO), all of which may be collectively referred to as “a cell (re)selection prioritization action.” A cell (re)selection prioritization action may be based on one or more criteria (e.g., as described herein).

Cell (re)selection prioritization criteria may include a network indication/configuration (e.g., an explicit network indication/configuration). In some examples, a WTRU may be configured to (e.g., explicitly configured to) perform a cell (re)selection prioritization action. For example, a WTRU may receive an RRCRelease message (e.g., actions for WTRU to perform in RRC IDLE state), or an RRCReleasewithSuspend message (e.g., actions for the WTRU to perform in RRC INACTIVE state). A message may include, for example, one or more of the following: an indication to enable/disable cell (re)selection prioritization; a method to prioritize cell (re)selection and/or associated configuration information (e.g., biases and associated criteria, as described herein); a type of network (e.g., terrestrial or non-terrestrial) or NTN deployment scenario (e.g., LEO or GEO) to prioritize; a duration to perform cell (re)selection prioritization (e.g., as described herein); and/or reporting criteria and/or associated report configurations (e.g., as described herein).

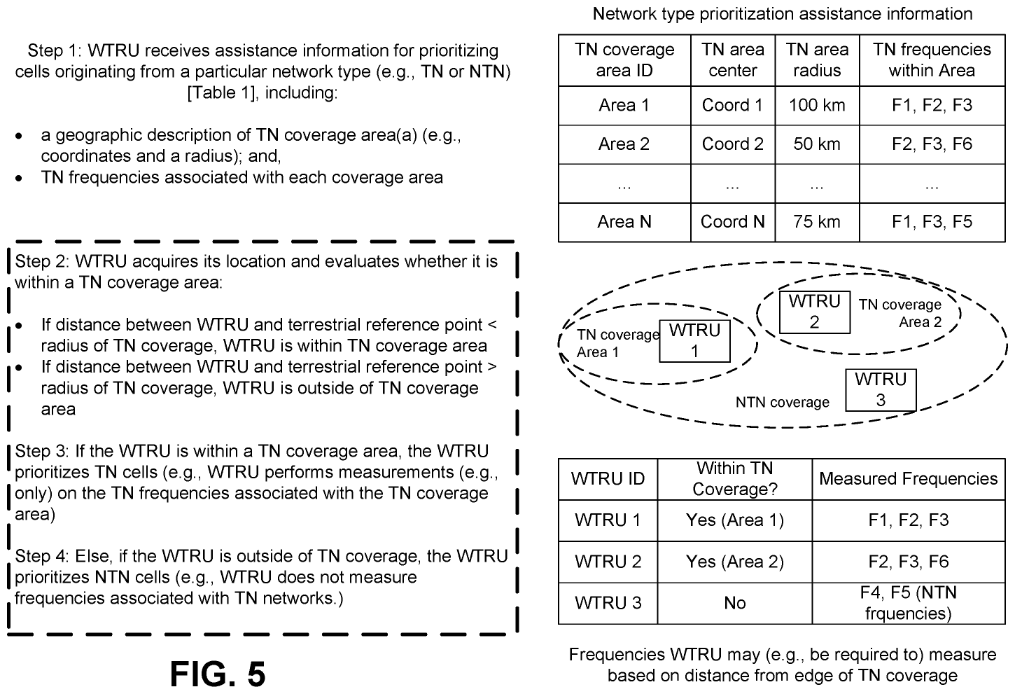

In some examples, a WTRU may receive an indication to perform a cell (re)selection prioritization action, and/or may receive one or more information items (e.g., as described herein, such as a geographic description of a TN coverage area (e.g., TN reference coordinate, TN radius), a geographic description of an NTN coverage area (e.g., NTN reference coordinate, NTN radius) and/or respective frequency information associated with the TN and NTN, as shown in FIG. 5), for example, via one or more of the following methods: within system information; within paging (e.g., via a paging short message); via DCI; and/or via random access signaling (e.g., msg2, msg4, msgB).

Cell (re)selection prioritization criteria may include WTRU speed. In some examples, a WTRU perform a cell (re)selection prioritization action based on the WTRU speed. For example, a stationary or low mobility WTRU may prioritize camping on a terrestrial cell, whereas a mobile or highly-mobile WTRU may prioritize camping on a non-terrestrial network. In another example, a stationary or low mobility WTRU may prioritize camping on a LEO cell, whereas a mobile or high-mobility cell may prioritize camping on a GEO cell.

A WTRU may detect WTRU speed/mobility via one or more of the following: a measurement variation; a relaxed monitoring status; WTRU positioning information; satellite positioning information; frequency compensation information; a number of cell (re)selections; a mobility-state estimation status; a mobility history record; and/or a relative speed between the WTRU and satellite.

A WTRU may detect WTRU speed/mobility via a measurement variation (e.g., based on the RSRP variation). Measurement criterion for a WTRU with low mobility may be fulfilled, for example, if (e.g., when): (SrxlevRef−Srxlev)<SSearchDeltaP, where Srxlev may be equal to a current Srxlev value of the serving cell (dB) or neighbor cell (dB) and SrxlevRef may be equal to a reference Srxlev value of the serving cell (dB) or neighbor cell (dB). The conditions for setting the Srxlevref may be based on time criteria, for example, if the low mobility criteria have not been met for TSearchDeltaP.

A WTRU may detect WTRU speed/mobility based on (e.g., via) a relaxed monitoring status. For example, the WTRU may determine it is in a low-mobility state based on activation of relaxed monitoring. For example, a low mobility state may be indicated by one or more (e.g., a combination of) criteria for low mobility (e.g., as described herein) and/or criteria based on WTRU not being at cell edge. Measurement criterion for a WTRU that may not be at a cell edge may be fulfilled, for example, if/when: Srxlev>SSearchThresholdP, and/or if/when Squal>SSearchThresholdQ (e.g., if SSearchThresholdQ may be configured).

A WTRU may detect WTRU speed/mobility via WTRU positioning information. For example the WTRU may use WTRU positioning information (e.g., taken, measured, or obtained at two or more times) to determine the WTRU speed.

A WTRU may detect WTRU speed/mobility via satellite positioning information. For example, the WTRU may use satellite positioning information (e.g., obtained via satellite assistance information, such as ephemeris data) taken (e.g., measured or obtained) at two or more times to determine the relative distance of the satellite to the WTRU (e.g., and by extension determine the WTRU speed).

A WTRU may detect WTRU speed/mobility via frequency compensation information. For example, the WTRU may use Doppler information to approximate WTRU speed.

A WTRU may detect WTRU speed/mobility via a number of cell (re)selections. For example, the WTRU may count the number of cell reselections (e.g., to cells originating from a terrestrial network and/or to cells originating from a non-terrestrial network) within a given period.

A WTRU may detect WTRU speed/mobility via a relative speed between the WTRU and satellite. For example, the WTRU may calculate the relative speed/distance between itself and the satellite, e.g., via the satellite ephemeris data.

In some examples, a WTRU camping on a TN network may evaluate low mobility criteria (e.g., according to methods described herein) based on measurements of the serving cell. A WTRU camping on an NTN network may evaluate low mobility criteria based on measurements performed on a neighboring cell (e.g., the TN neighbor cell). For example, low mobility criteria may be evaluated based on a Srxlev value of a neighbor cell (dB). A WTRU may use one or more parameters provided by the cell (e.g., the current NTN cell).

In some examples, the WTRU may maintain/store information regarding speed, direction, or velocity. In some examples, the WTRU may maintain a mobility state e.g., stationary, low mobility, medium mobility, or high mobility. A state (e.g., each state) may be associated with a (e.g., determined, indicated, configured) set of criteria (e.g., a speed threshold, a number of cell (re)selections/hour). The WTRU may enter the associated mobility state based on (e.g., upon) satisfaction of the criteria.

A WTRU may maintain a different mobility state for terrestrial and/or non-terrestrial networks. For example, the WTRU may maintain multiple (e.g., two) separate mobility states associated with a terrestrial and non-terrestrial network, e.g., TNMobilityState and NTNMobilityState, respectively. The WTRU may use different metrics to evaluate a terrestrial mobility state (e.g., measurement variation, cell (re)selection frequency) and non-terrestrial mobility state (e.g., satellite positioning information, WTRU-satellite relative speed). The WTRU may maintain a mobility state, for example, based on a virtual cell reselection count of cell changes on a TN. A WTRU may evaluate a cell reselection, for example, based on cell measurements of neighbor cells on a neighboring TN, for example, while the WTRU is camped on NTN and not performing reselection.

Cell (re)selection prioritization criteria may include WTRU distance (e.g., determining whether the WTRU is within coverage of a TN or NTN). FIG. 5 illustrates an example of cell selection based on a WTRU location and distance from network coverage areas. In some examples, a WTRU may perform a cell (re)selection prioritization action based on the distance between the WTRU and a reference point (e.g., the WTRU may determine a distance between the WTRU and a terrestrial reference point associated with a TN coverage area). The WTRU may monitor one or more distances, and/or may perform one or more actions (e.g., selecting a network type and/or performing reselection to a TN or NTN), for example, if the distance meets, exceeds, and/or falls below a threshold criterion (e.g., the WTRU may determine whether the distance between the WTRU and the terrestrial reference point is above or equal to a threshold (e.g., radius of TN or NTN coverage) associated with location information, as shown in FIG. 5). The distance threshold may be based on, for example, one or more of the following: the WTRU-satellite distance; the distance between the WTRU-satellite cell center; the distance between the WTRU and satellite footprint; the distance between the WTRU and a terrestrial-based gNB; the distance between the WTRU and the edge of terrestrial coverage; and/or the distance between a WTRU and a reference point. For example, the WTRU may be within a coverage area (e.g., TN or NTN) if the distance between the WTRU and the reference point (e.g., center of coverage area) is less than a threshold (e.g., radius of coverage area), as shown in FIG. 5. The WTRU may be outside a coverage area (e.g., TN or NTN) if the distance between the WTRU and the reference point (e.g., center of coverage area) is above or equal to the threshold (e.g., radius of coverage area), as shown in FIG. 5. The WTRU may determine to select (e.g., prioritize selecting) a TN, for example, if the WTRU is within the TN coverage area (e.g., as shown in FIG. 5). The WTRU may perform measurements based on the cell selection (e.g., perform measurement(s) on the frequency or frequencies associated with the selected network, for example, such as performing measurement(s) on the frequencies associated with the TN if the WTRU is within the TN coverage area), as shown in FIG. 5.

Cell (re)selection prioritization criteria may include a WTRU configuration information, state, and/or characteristics.

In some examples, the WTRU may perform a cell (re)selection prioritization action based on a WTRU configuration information (e.g., the current WTRU configuration), a WTRU state, and/or one or more WTRU characteristics. Examples of WTRU aspects that may affect cell (re)selection prioritization may be, for example, one or more of the following: the network type of the cell a WTRU may be camped on (e.g., may currently be camped on); the network type of the cell a WTRU may have been released from (e.g., the network type that provided the WTRU with an RRCRelease or RRCReleasewithSuspend message); QoS characteristics or historic traffic profile of WTRU data; WTRU device type (e.g., the WTRU may be a VSAT device, the WTRU may prioritize cells from a non-terrestrial network); a WTRU capability (e.g., whether the WTRU is capable of connection to an NTN cell); whether the network-type or NTN deployment scenario frequencies overlap; RRC state (e.g., a WTRU may apply different cell (re)selection prioritization methods based on/upon reception of an RRCRelease message, such as an RRC IDLE WTRU, or based on/upon reception of an RRCReleasewithSuspend message, such as an RRC INACTIVE WTRU); and/or the number of detected cells belonging to a network type (e.g., if a WTRU may not detect cells of a network type on one or more frequencies, the WTRU may prioritize another network type or, if the WTRU detects more than a number X of cells belonging to network type, the WTRU may prioritize the network type during cell (re)selection).

Cell (re)selection prioritization may be based on a DRX configuration, a paging cycle, and/or a RACH configuration. In some examples, a WTRU may perform a cell (re)selection prioritization action based on one or more WTRU configurations, which may include, for example one or more of the following: a DRX length, a paging cycle length, and/or a RACH configuration.

A WTRU may perform a cell (re)selection prioritization action based on a DRX length. For example, a WTRU configured with a long DRX (e.g., eDRX) may prioritize a cell (re)selection to a cell originating from a non-terrestrial network or a GEO NTN deployment scenario. A WTRU configured with a short(er) DRX cycle may prioritize cell (re)selection to a cell originating from a terrestrial cell or LEO NTN deployment scenario.

A WTRU may perform a cell (re)selection prioritization action based on a paging cycle length. For example, a WTRU configured with a long paging cycle may prioritize a cell (re)selection to a cell originating from a non-terrestrial network or GEO NTN deployment scenario. A WTRU configured with a short(er) paging cycle may prioritize cell (re)selection to a cell originating from a terrestrial cell or LEO NTN deployment scenario. A WTRU may prioritize camping on cells originating from a non-terrestrial network, for example, if the WTRU may not have been paged within an amount of time or within a duration of time (e.g., may not have been paged within in X time units). The WTRU may prioritize connection to a terrestrial network, for example, if the WTRU has last received paging or was released from a connected state by a terrestrial cell (e.g., a WRTI received an RRCRelease or RRCReleasewithSuspend message from a terrestrial cell.

A WTRU may perform a cell (re)selection prioritization action based on a RACH configuration. For example, a WTRU may prioritize a network type with RACH occasions closest to the paging occasion (e.g., to rapidly respond to paging).

Cell (re)selection prioritization may be based on power saving metrics. In some examples, a WTRU may perform a cell (re)selection prioritization action based on WTRU power. A WTRU may alter cell (re)selection prioritization (e.g., the WTRU may prioritize a non-terrestrial over terrestrial cell, or cells from a GEO NTN deployment over a LEO NTN deployment), for example, if the WTRU may have entered a WTRU power saving state or power saving mode (PSM).

In some examples, a WTRU may perform a cell (re)selection prioritization action based on a power saving preference. For example, a WTRU may perform a cell (re)selection prioritization action based on an application layer-based preference (e.g., a selected power saving preference). In some examples, a WTRU may indicate a preference to the network, e.g., in a WTRU assistance information message. The network may (e.g., in response) provide updated cell reselection priorities for the WTRU to apply if/when performing a cell reselection evaluation.

Cell (re)selection prioritization may be implemented in one or multiple methods, which may be selected, determined, configured, indicated, etc.

A WTRU may perform cell reselection prioritization, for example, based on (e.g., upon) configuration, indication, or satisfaction of one or more criteria (e.g., as described herein, such as whether the WTRU is within a TN or NTN coverage area). The WTRU may determine which cell (re)selection prioritization method is selected, and/or which network type or NTN deployment scenario may be prioritized based on, for example, the received configuration information, the contents of the indication, and/or which criteria have been satisfied.

Network type prioritization may be implemented based on (e.g., via) measurement bias. In some examples, a WTRU may receive and/or be configured with one or more cell (re)selection bias(es) to apply to cell ranking measurements, for example, to prioritize camping on a network type or for an NTN deployment scenario. A bias may be positive or negative. A bias may have one or more associated criteria to apply the bias. Criteria may include, for example, one or more of the following: a network type (e.g., terrestrial or non-terrestrial), for example, where a WTRU may apply the bias to one or more (e.g., all) cells/frequencies belonging to the network type; an NTN deployment scenario (e.g., LEO or GEO), for example, where a WTRU may apply the bias to one or more (e.g., all) cells/frequencies belonging to the deployment scenario; a PLMN ID, for example, where the WTRU may apply the bias to one or more (e.g., all) cells/frequencies associated with the PLMN; a cell ID, for example, where the WTRU may apply the bias to the cell; a frequency or range of frequencies, for example, where the WTRU may apply the bias to one or more (e.g., all) frequencies at the indicated frequency or within the indicated range of frequencies; a threshold, where, for example, the WTRU may apply a bias if a prioritization criteria (e.g., as described herein) meets, exceeds, or falls below a threshold; and/or a state, where, for example, the WTRU may apply a bias if a prioritization criteria (e.g., as described herein) or configuration may be equivalent to the indicated state.

A WTRU may be configured with multiple biases. A WTRU may apply one or more (e.g., all) biases for which the associated criteria has been satisfied. In some examples, a WTRU may select and apply a bias by selecting a bias having the largest absolute value among multiple (e.g., all) biases applied to a network type, NTN deployment scenario, PLMN, and/or frequency range. In some examples, a WTRU may select and apply one or more biases, for example, by selecting the largest positive and negative bias applied to a network type, NTN deployment scenario, PLMN, and/or frequency range. The WTRU may apply the sum of the multiple biases.

Network type prioritization may be independent of measurements. In some examples, a WTRU may prioritize a network type independently of measurements (e.g., regardless of whether the best frequency/cell belongs to a preferred network type). For example, the WTRU may (e.g., only) evaluate candidate cells from the network type, or may (e.g., alternatively) evaluate candidate cells from a second network type (e.g., only) after all frequencies/candidate cells have been evaluated from the first network type.

Candidate cells/frequencies may be eliminated based on network type. In some examples, a WTRU may prioritize a network type or deployment scenario by downselecting or eliminate candidate cells for cell (re)selection based on network type. For example, a WTRU may eliminate candidate cells for (re)selection that originate from a network type (e.g., terrestrial vs. non-terrestrial) or an NTN deployment scenario (e.g., LEO vs. GEO). A WTRU may eliminate candidate cells and/or frequencies, for example, based on (e.g., via) one or more of the following methods: barring cells associated with a network type or deployment scenario; barring/not performing measurements on frequencies associated with a network type or deployment scenario; and/or barring PLMNs associated with a network type or deployment scenario.

Network-type prioritization may be based on non-overlapping frequencies. In some example deployments, terrestrial and/or non-terrestrial networks may be associated with unique frequencies. A WTRU may group frequencies associated with a specific network type. The WTRU may (e.g., then) determine which network type may be prioritized. The WTRU may perform cell ranking, for example, based on the associated set of frequencies. A WTRU may (e.g., if no suitable cells are found) attempt to perform cell ranking on the frequency set belonging to the de-prioritized network type.

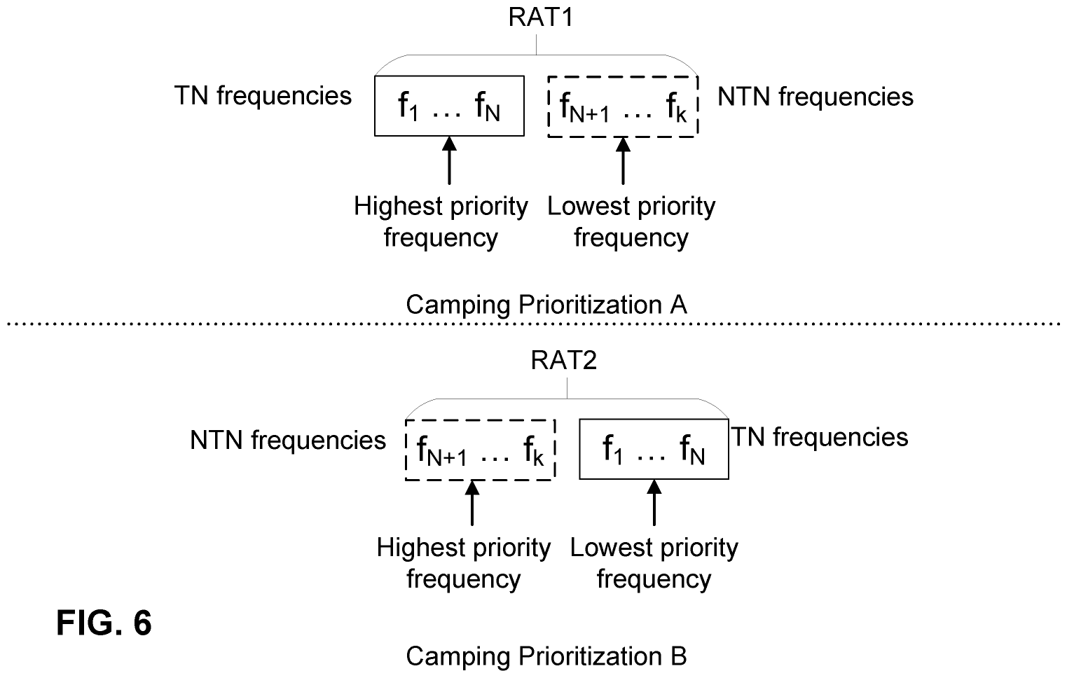

In deployments where terrestrial and non-terrestrial networks may be associated with one or more frequencies (e.g., unique frequencies) the WTRU may group frequencies associated with a network type. The WTRU may determine which network type may be prioritized, and may perform cell ranking based on the associated set of frequencies. If no suitable cells may be found, the WTRU may attempt to perform cell ranking on the frequency set belonging to the de-prioritized network type. This may be exemplary shown in FIG. 6 for TN-NTN prioritization, wherein during prioritization A the WTRU may camp (e.g., attempt camping) on one or more terrestrial frequencies (e.g., all terrestrial frequencies), and during prioritization B the WTRU may camp (e.g., attempt camping) on non-terrestrial frequencies (e.g., all non-terrestrial frequencies). This procedure may similarly be used to priorities between different NTN deployment scenarios (e.g., if associated with different frequencies).

FIG. 6 shows an example for TN-NTN prioritization. As shown in FIG. 6, at camping prioritization A, a WTRU may attempt camping on one or more (e.g., all) terrestrial frequencies before attempting camping on NTN frequencies. As shown in FIG. 6, at camping prioritization B, the WTRU may attempt camping on one or more (e.g., all) non-terrestrial frequencies before camping on TN frequencies. This procedure may similarly be used to prioritize between different NTN deployment scenarios (e.g., if associated with different frequencies).

FIG. 6 illustrates an example of grouping frequencies associated with different network types. For example, FIG. 6 may show an example of grouping frequencies associated with different network types prior to cell ranking prior. Network-type prioritization may be based on overlapping frequencies. In some example deployments, terrestrial and non-terrestrial networks may have overlapping frequencies. A WTRU may (e.g., always) select a particular network type, for example, if a frequency has suitable cells available from terrestrial and non-terrestrial networks.

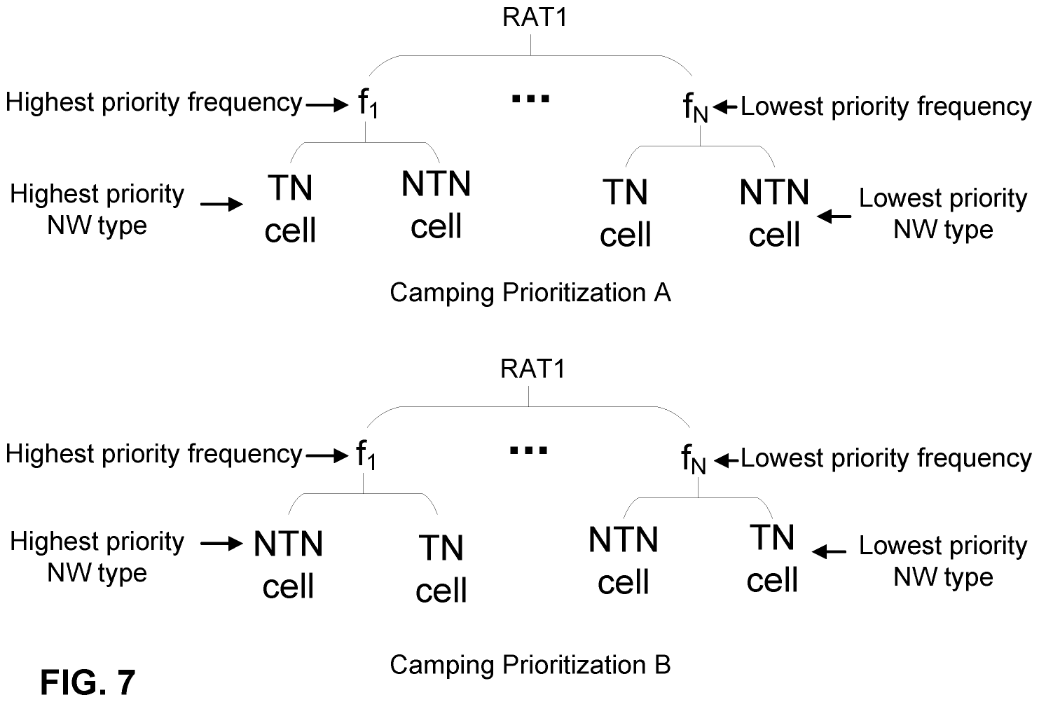

Network-type prioritization with overlapping frequencies may be provided. FIG. 7 shows an example of network-type prioritization based on overlapping frequencies. In deployments where terrestrial and non-terrestrial networks have overlapping frequencies, if a frequency has suitable cells available from both terrestrial and non-terrestrial networks, the WTRU may select a network type (e.g., a particular network type). For example, in FIG. 7, at prioritization A, if the priority frequency f1 (e.g., highest priority frequency f1) has both suitable terrestrial and non-terrestrial cells, the WTRU may select the terrestrial cell. In prioritization B, the WTRU may select the non-terrestrial cell.

If a high ranked frequency (e.g., the highest ranked frequency) contains cells from both terrestrial and non-terrestrial networks and cell(s) (e.g., only cell(s)) from one network type are suitable, the WTRU may select that cell regardless of whether the cell originates from the preferred network type. For example, in FIG. 7, at prioritization A, if frequency f1 (e.g., the highest priority frequency f1) has suitable cells (e.g., only suitable cells) from non-terrestrial networks, the WTRU may select the non-terrestrial cell.

As shown in FIG. 7, at camping prioritization A, the WTRU may (e.g., always) select the terrestrial cell if the frequency f1 (e.g., highest priority frequency f1) has suitable terrestrial and non-terrestrial cells. As shown in FIG. 7, at camping prioritization B, the WTRU may (e.g., always) select the non-terrestrial cell if the frequency f1 (e.g., highest priority frequency f1) has suitable terrestrial and non-terrestrial cells.

The WTRU may select a cell regardless of whether the cell originates from the preferred network type, for example, if the highest ranked frequency includes cells from terrestrial and non-terrestrial networks and cell(s) from (e.g., only) one network type are suitable. For example, as shown in FIG. 7, at camping prioritization A, the WTRU may select the non-terrestrial cell if frequency f1 (e.g., the highest priority frequency f1) has suitable cells (e.g., only) from non-terrestrial networks.

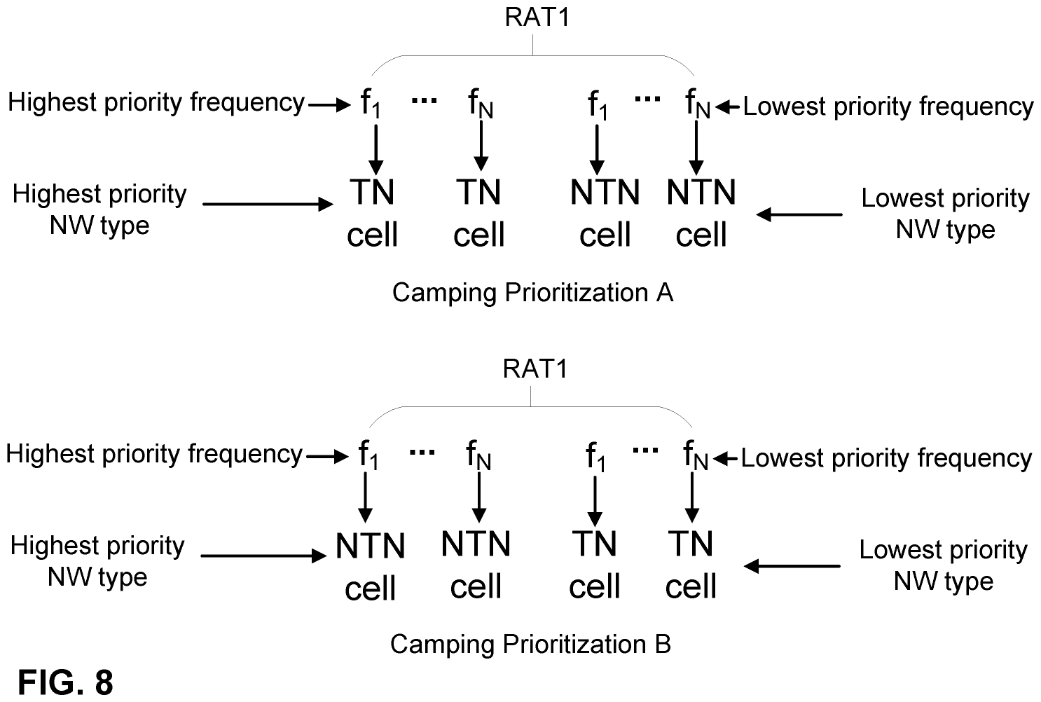

FIG. 8 illustrates an example of prioritization of a network type over frequency. In an example, if a high ranked frequency (e.g., the highest ranked frequency) contains cells from both terrestrial and non-terrestrial networks and cells (e.g., only cell(s) from the non-preferred network type may be suitable, the WTRU may move to the next highest-priority frequency until a suitable cell from the preferred network type may be found. For example, in FIG. 8, at prioritization A, if frequency f1 (e.g., which be the highest priority frequency f1) has suitable cells (e.g., only suitable cells) from non-terrestrial networks, the WTRU may attempt to connect to a terrestrial cell on frequency f2. If no suitable cells may be found on any frequency, then the WTRU may connect to a suitable NTN cell on the highest priority frequency. At prioritization B, the WTRU may prefer the non-terrestrial cell.

In some examples, a WTRU may move to the next highest-priority frequency until a suitable cell from the preferred network type is found, for example, if a high ranked frequency (e.g., the highest ranked frequency) includes cells from terrestrial and non-terrestrial networks and cell(s) from (e.g., only) the non-preferred network type is suitable. For example, as shown in FIG. 8, at camping prioritization A, the WTRU may (e.g., attempt to) connect to a terrestrial cell on frequency f2 if the highest priority frequency f1 has suitable cells (e.g., only) from non-terrestrial networks. The WTRU may connect to a suitable NTN cell on a high priority frequency (e.g., the highest priority frequency), for example, if a suitable cell is not found on any frequency. As shown in FIG. 8, camping prioritization B, the WTRU may attempt to connect to the non-terrestrial cell on frequency f2 if the highest priority frequency f1 has suitable cells (e.g., only) from terrestrial networks.

Prioritization may have a duration (e.g., in terms of time or a count). In some examples, a WTRU may apply a cell (re)selection prioritization semi-statically (e.g., based on configuration). In some examples, a WTRU may apply cell (re)selection prioritization based on satisfaction of a criteria (e.g., as described herein).

A WTRU may apply time-based switching between prioritizations. In some examples, a WTRU may apply cell (re)selection prioritization temporarily (e.g., subject to timing conditions). A timing condition for prioritization may include or may be indicated by, for example, one or more of the following: while a time is running, while a period of time elapses, subject to a counter, until an indicated time, and/or for a time period.

A timing condition for prioritization may be indicated by a timer (e.g., while a timer is running) and/or a period of time that may elapse. For example, a WTRU may (e.g., based on/upon application of cell (re)selection prioritization) start a timer, may determine a duration of time, and/or the like. The WTRU may stop cell (re)selection prioritization upon expiry of the timer, upon the passing of a duration of time, and/or the like.

A timing condition for prioritization may include or may be indicated by a counter (e.g., prioritization subject to a counter). For example, a WTRU may apply cell (re)selection prioritization for the next X resources (e.g., frames, subframes, symbols).

A timing condition for prioritization may include or may be indicated by an indicated time (e.g., prioritization until an indicated time). For example, a WTRU may apply cell (re)selection prioritization until 10:00:35 UTC.

A timing condition for prioritization may include or may be indicated by a (e.g., general or specific) time period (e.g., prioritization for a time period). For example, a WTRU may apply cell (re)selection prioritization for five minutes, which may be specific, such as between 10:00:35 UTC and 10:00:40 UTC.

In some examples, a WTRU may track a time (e.g., start a timer) based on (e.g., upon) release to RRC IDLE/INACTIVE mode (e.g., reception of an RRCRelease or RRCReleasewithSuspend message). The WTRU may apply cell (re)selection prioritization (e.g., only) for the indicated or configured duration. In some examples, the WTRU may start tracking a time (e.g., via a timer or counter) based on (e.g., upon) starting cell (re)selection prioritization. In some examples, the WTRU may start tracking a time (e.g., via a timer or counter) after the last time the WTRU camped on a cell belonging to a network type (e.g., terrestrial or non-terrestrial cell). In some examples, an offset may be (e.g., optionally) applied to time (e.g., the start of the timer or counter).

The WTRU may stop tracking a time (e.g., via a timer), for example, based on (e.g., upon the occurrence of) one or more of the following: successful connection establishment (e.g., transmission of the RRCSetupComplete or RRCREsumeComplete message); attempted connection establishment (e.g., transmission of an RRCSetupRequest or RRCResumeRequest message); transmission of a random access message (e.g., msgA, msg1, msg3, or msg5); reception of a random access message (e.g., msgB, msg2, msg4); and/or application of a different prioritization configuration.

A WTRU may (e.g., based on/upon expiry of the timing condition(s) perform one or more of the following actions: stop applying cell (re)selection prioritization; revert to a default or alternate cell (re)selection prioritization configuration/method; discard associated cell (re)selection prioritization configuration(s); perform cell (re)selection; and/or perform random access (e.g., transmit a preamble).

Prioritizations may be periodic. In some examples, a WTRU may apply cell (re)selection prioritization periodically. For example, a WTRU may be provided with a series of times in which to apply cell (re)selection prioritization.

In some examples, a WTRU may be provided/configured with a time (e.g., UTC 10:00:32) and/or an offset (e.g., 5 minutes or X frames). For example, a WTRU/WTRU-side may apply cell (re)selection prioritization at each original time+X*Offset. The offset multiplier X may be a configurable number (e.g., an integer).

In some examples, a WTRU may be provided with multiple times (e.g., timers), such as a cycle duration and an on duration. As described herein a timer may refer to a period of time that may elapse. The WTRU may apply cell (re)selection prioritization while the on duration time (e.g., timer) is running, while a period of time is passing, and/or while within a period of time. The WTRU may (e.g., based on/upon expiry of the on duration timer and/or when a period of time has elapsed) wait until the cycle duration (e.g., timer) restarts before starting the on duration (e.g., timer) again (e.g., the WTRU may re-apply cell (re)selection prioritization).

WTRU-based TN/NTN prioritization may be reported (e.g., by a WTRU to a network). In some examples, a WTRU may report that it has applied cell (re)selection prioritization, and/or information/characteristics regarding cell (re)selection prioritization. The WTRU may report, for example, one or more of the following: whether the WTRU is applying cell (e.g., currently applying cell (re)selection prioritization); the currently prioritized network type and/or NTN deployment scenario; the prioritization method; which cell (re)selection criteria have been satisfied and/or the current state of a cell (e.g., each cell) (re)selection prioritization criteria; and/or the remaining duration (e.g., a remaining duration of time) the WTRU may apply the cell (re)selection prioritization.

A WTRU may report information regarding cell (re)selection prioritization based on, for example: whether reporting is configured as enabled; in response to network request (e.g., WTRU may receive an indication in paging or system information); based on (e.g., upon) application of cell (re)selection prioritization; based on (e.g., upon) a change of cell (re)selection prioritization (e.g., if the WTRU has changed preference of network type); based on (e.g., upon) WTRU connection setup (e.g., during random access).

A WTRU may report information regarding cell (re)selection prioritization, for example, via RRC signaling or MAC CE. A report may be sent, for example: during a random access procedure (e.g., via msgA, msg3, or msg5); via dedicated resources (e.g., stored grants, configured grant occasions, or periodically reserved resources for WTRU reporting), and/or using previously provided resources (e.g., provided in a RRCRelease or RRCReleasewithSuspend).

In some examples, a WTRU may receive an RRCRelease message from a non-terrestrial network including one or more of: a prioritization configuration, criteria to apply the prioritization, and/or a duration to apply the configuration. The WTRU may (e.g., while performing cell (re)selection) detect that one or more of the prioritization criteria have been satisfied (e.g., the RSRP of a terrestrial cell increased by a threshold). The WTRU may (e.g., based on/upon satisfaction of the prioritization criterion) apply a cell (re)selection priority configuration, which may prioritize terrestrial networks, for example, by grouping (e.g., all) terrestrial frequencies and attempting selection of a suitable cell on (e.g., all) terrestrial frequencies before attempting selection of a suitable cell on non-terrestrial frequencies. The WTRU may (e.g., based on/upon application of the prioritization configuration) start a timer and/or determine a period of time that may be allowed to lapse. The WTRU may (e.g., while the timer is running, while within a period of time, and/or as a period of time is passing) continue to perform cell reselection via the prioritized configuration, for example, until a connection is established (e.g., via random access) or upon expiry of the timer (e.g., when a period of time elapses). The WTRU may (e.g., based on/upon timer expiry) revert back to a different (e.g., default) cell reselection priority, and/or may re-attempt cell (re)selection.

In some examples, a WTRU may receive an RRCRelease message from a terrestrial network. The message may include one or more of: a prioritization configuration, a criteria to apply the prioritization, and/or a duration to apply the configuration. The WTRU may (e.g., while performing cell (re)selection) detect that one or more of the prioritization criteria have been satisfied (e.g., the RSRP of a terrestrial cell decreased by a threshold). The WTRU may (e.g., based on/upon satisfaction of the prioritization criterion) apply a cell (re)selection priority configuration that prioritizes non-terrestrial networks, for example, by (e.g., via) grouping (e.g., all) non-terrestrial frequencies and attempting selection of a suitable cell on (e.g., all) non-terrestrial frequencies before attempting selection of a suitable cell on terrestrial frequencies. The WTRU may (e.g., based on/upon application of the prioritization configuration) start a timer. The WTRU may (e.g., while the timer is running) continue to perform cell reselection via the prioritized configuration, for example, until a connection is established (e.g., via random access) or until expiry of the timer. The WTRU may (e.g., based on/upon timer expiry) revert back to a different (e.g., default) cell reselection priority, and/or may re-attempt cell (re)selection.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-15. (canceled)

16. A wireless transmit/receive unit (WTRU) comprising:
a processor configured to:
receive prioritization configuration information that indicates a network prioritization configuration, a prioritization condition, and a duration associated with applying the network prioritization configuration;
determine that the prioritization condition has been satisfied;
determine to apply the network prioritization configuration based on the determination that the prioritization condition has been satisfied; and
perform cell reselection, wherein if the duration associated with applying the network prioritization configuration has not elapsed, the cell reselection is performed using the network prioritization configuration.

17. The WTRU of claim 16, wherein the determination that the prioritization condition has been satisfied comprises a determination that a reference signal received power associated with a terrestrial cell has exceeded a threshold.

18. The WTRU of claim 16, wherein if the duration associated with applying the network prioritization configuration has elapsed, the cell reselection is performed using a default cell reselection prioritization configuration.

19. The WTRU of claim 16, wherein the network prioritization configuration is a terrestrial network (TN) prioritization configuration, and wherein the prioritization condition is a TN prioritization condition.

20. The WTRU of claim 19, wherein the cell reselection performed using the TN prioritization configuration comprises determining a group of terrestrial frequencies for selection, wherein group of terrestrial frequencies for selection has a higher selection priority than a group of non-terrestrial frequencies.

21. The WTRU of claim 16, wherein the network prioritization configuration is a non-terrestrial network (NTN) prioritization configuration, and wherein the prioritization condition is an NTN prioritization condition.

22. The WTRU of claim 16, wherein the determination that the prioritization condition has been satisfied comprises a determination that a reference signal received power associated with a terrestrial cell has decreased by a threshold.

23. A method comprising:
receiving prioritization configuration information that indicates a network prioritization configuration, a prioritization condition, and a duration associated with applying the network prioritization configuration;
determining that the prioritization condition has been satisfied;
determining to apply the network prioritization configuration based on the determination that the prioritization condition has been satisfied; and
performing cell reselection, wherein if the duration associated with applying the network prioritization configuration has not elapsed, the cell reselection is performed using the network prioritization configuration.

24. The method of claim 23, wherein the determination that the prioritization condition has been satisfied comprises a determination that a reference signal received power associated with a terrestrial cell has exceeded a threshold.

25. The method of claim 23, wherein if the duration associated with applying the network prioritization configuration has elapsed, the cell reselection is performed using a default cell reselection prioritization configuration.

26. The method of claim 23, wherein the network prioritization configuration is a terrestrial network (TN) prioritization configuration, and wherein the prioritization condition is a TN prioritization condition.

27. The method of claim 26, wherein the cell reselection performed using the TN prioritization configuration comprises determining a group of terrestrial frequencies for selection, wherein group of terrestrial frequencies for selection has a higher selection priority than a group of non-terrestrial frequencies.

28. The method of claim 23, wherein the network prioritization configuration is a non-terrestrial network (NTN) prioritization configuration, and wherein the prioritization condition is an NTN prioritization condition.

29. The method of claim 23, wherein the determination that the prioritization condition has been satisfied comprises a determination that a reference signal received power associated with a terrestrial cell has decreased by a threshold.
